(19) United States
(12) Patent Application Publication
(10) Pub. No.: US 2015/0076231 A1
(43) Pub. Date: Mar. 19, 2015

(54) Ultra Thin Proximity Card Reader

(71) Applicant: Charles Buccola, Amityville, NY (US)

(72) Inventor: Charles Buccola, Amityville, NY (US)

(21) Appl. No.: 14/031,491

(22) Filed: Sep. 19, 2013

(51) Int. Cl. G06K 7/10; H01Q 1/22; H01Q 7/06

(52) U.S. Cl. CPC G06K 7/10336; H01Q 7/06; H01Q 1/2216
USPC 235/439; 343/788; 29/601

(57) ABSTRACT

The proximity readers for opening a door are typically located on a lock, a metal prison wall, on a metal fire door, on a metal door frame. Traditionally, a proximity reader had to be made thick so that the pickup coil/antenna was not close to the metallic mounting surface otherwise the reader's read range would be drastically reduced. The present invention eliminates the problem of these metal surfaces reducing the read range of the proximity reader when mounted on these types of metallic surfaces. The present invention allows the pickup coil/antenna to be mounted close to the metallic mounting surface, be low profile without reducing the read range.

### BACKGROUND OF THE INVENTION

1. Field of the Invention

The present invention relates generally to a method of improving a security proximity card reader's performance and construction of an ultra thin proximity card reader and more particularly to a method of constructing an ultra thin reader that can be mounted directly on a metallic surface without reducing its read range.

2. Description of Related Art

A proximity card reader is the mechanism that is placed next to a locked door and serves to unlock said door when a proximity card is held near or passed over the proximity card reader. Data read from the card is then processed by some control device and if authenticated, unlocks the proper door.

A proximity card reader and proximity card communicate with each other through radio frequency fields of typically 125 kHz, or 13.56 MHz or other frequencies if available. The proximity cards have an antenna consisting of a coil of wire, a capacitor, and an integrated circuit, which contains specific data for the system in which it is to be used. The proximity card reader has its own antenna usually consisting of a coil of wire. The reader continuously transmits a short range radio frequency signal intended to detect and communicate with cards. In free space this antenna has a well defined field on all sides of the coil. A proximity reader with such an antenna will have read range based on the readers power output and receiver sensitivity.

However, in actual practice the antenna of a proximity card reader is mounted in some convenient housing. The proximity readers for opening a door are typically located directly on a lock housing, a wall adjacent to a door or on a metal door frame. Most lock housing are made of metal such as Zinc, Brass, Steel or Stainless steel. When a proximity readers antenna is place near metal its signal field becomes, weakened and distorted. Consequently the reader can lose all or some of its read range.

As a result, in order for a reader to be effective in reading a proximity card, that means, to be able to read card from an acceptable distance, most proximity card reader antenna housings have to be made large and deep with the objective of getting the antenna far enough away from any metal mounting surface.

Consequently, in the past, the antenna housing and mounting position were a compromise between best read range and the practical aesthetics of the product.

Therefore, it would be of great benefit to improve a proximity card reader's immunity to nearby metal mounting surfaces so that it can be installed on such surfaces without having to increase the size, in height or width, of the antenna or compromising the readers best read range.

### SUMMARY OF THE INVENTION

One object of the present invention is to provide a method to reduce the thickness of a security system proximity card reader, and allow mounting directly on a metallic surface while maintaining good card read range

This is achieved by placing a Ferrite plate on one side of the antenna coil. Ferrite is a term for pure iron with properties know as a body centered cubic crystal structure. This unique structure is what enables cast iron as well as steel to have magnetic properties.

This material when used here in this invention provides a low loss path for the field surrounding the coil acting as a shield against any nearby metal. It thereby effectively leaves only the signals emanating in a forward, desired direction available to read cards.

This is in sharp contrast to traditional proximity card reader devices which send the signal out in all directions. It is this unique feature that allows for the card reader described herein to be thin in size and still work on metal surfaces with a powerful signal for communication with a proximity card that is passed over the proximity card reader.

In an exemplary embodiment of the present invention, there is disclosed a method of improving the performance of a proximity card reader which comprises placing a pickup coil onto a ferrite material and placing the pickup coil together with the ferrite material into an appropriate housing for assembling an end product, wherein the ferrite material redirects the magnetic energy of the proximity card reader antenna so that it does not get absorbed by the metal of the lock or door or wall behind it. The coil is placed on then adhered by gluing or other means to the ferrite plate(s) then placed in some appropriate housing for the end product. Totally encapsulating the antenna is also possible when a robust structure designed to handle vibration and impact is required. By using ferrite material/plate/wafer/component in conjunction with a tuned proximity pickup coil, the thickness of a proximity reader can be reduced, its read range for detecting cards can be optimized and it can be mounted directly on a metallic surface without reducing its performance.

In an exemplary embodiment of the present invention, there is disclosed an improved antenna which comprises a pickup coil and a ferrite material that is located below the pickup coil and extends beyond the pickup coil's outside perimeter. Although the ferrite material does not need to extend beyond the pickup coil's outside perimeter, the performance is decreased if not. The electronics are not directly involved with the improved antenna. The detailed construction and operation of the electronics such as reader boards of the proximity reader forms no part of this improved antenna and is therefore not described herein. It is contemplated that any suitable commercially available electronics/reader boards could be employed to make an ultra thin proximity reader as long as the improved antenna of the present invention is used.

The improved antenna can work with most off-the-shelf proximity reader boards at 125 KHz, 13.56 MHz, or other frequencies if they are available. The only requirement for the improved antenna of the present invention to function with most reader boards is to properly tune and match the improved antenna of the present invention to the specified load impedance required by the reader board's circuitry. The improved antenna of the present invention has been tested with off the shelf proximity reader boards supplied by HID corp. at both 125 KHz and 13.56 MHz.

In an exemplary embodiment of the present invention, there is disclosed an ultra thin proximity card reader which comprises a pickup coil and a ferrite material that is located below the pickup coil and extends beyond the pickup coil's outside perimeter, electronics or reader boards, wire leads connected between the coil and the electronics or reader boards, and a housing to enclose all the aforementioned components. The housing is normally non-metallic and the shape may change for aesthetics.

The pickup coil is the actual active antenna. It can vary from one or two coils to more than 75 depending on the size and frequency desired. It can also be made as traces on a small printed circuit board.

The ferrite material is used to eliminate the negative effects of metal in the lock or door or wall upon which the proximity reader is installed because the high electrical resistance of the ferrite material leads to very low eddy current/magnetic field losses when conducting the magnetic field at the frequencies used by proximity cards. In other words, the ferrite material acts like a shield to contain the magnetic field within the boundary of ferrite material and prevents the magnetic field from being absorbed by the metal in the lock or in the wall upon which the proximity reader is mounted. This ferrite material and its position inside the proximity reader of the present invention allows most of the power applied to the coil to be available for reading proximity cards on the non shielded side of the coil which is the front side for the proximity card to be held near or passed over.

Therefore, these ultra thin proximity card readers can be used on doors and locks in hotels that have metal backings and remain slim and appealing visually.

One of the embodiments of the present invention has been tested for the read range during development and has been verified that the performance is close to free air range of about one inch when the antenna on top of the ferrite plate is placed on a typical Zinc die cast lock housing. As a control group, a conventional antenna when placed on metal will fail to perform at all. The proximity card readers of the present invention can operate on either batteries or ac/dc power. One embodiment of the present invention achieves ranges of about 0.25 inch up to 1 inch for both battery operated or AC/DC devices

This means that a card does not have to be physically pressed against the proximity card reader antenna in order for it to be read. It merely needs to be passed near the proximity card reader itself.

In one embodiment, the ferrite material used may be available as hard sintered plates and shapes. In another embodiment, the ferrite material used may be flexible rubberize versions. The ferrites material used in the embodiments may be a solid plate or several small plates. In a preferred embodiment, several plates make possible curved or shaped antennas.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a partially exploded view of an ultra thin proximity card reader according to one embodiment of the present invention.

FIG. 2 is a sectional view along A-A of the proximity card reader of FIG. 1.

FIG. 3 Field Lines confined to Ferrite plate

### DESCRIPTION OF THE PREFERRED EMBODIMENT

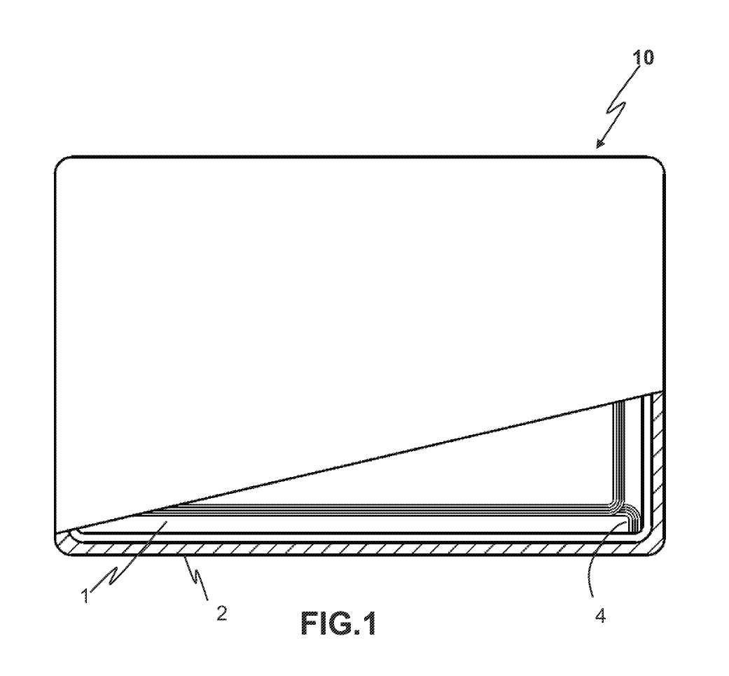

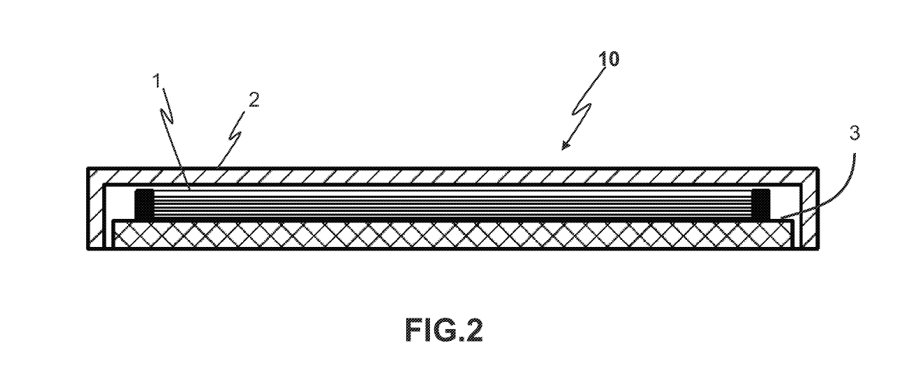

Referring to FIGS. 1-3 there is disclosed an ultra thin proximity card reader according to one embodiment of the present invention. The ultra thin proximity card reader 10 comprises a pickup coil/antenna 1 and a ferrite plate 3. The ferrite plate 3 is located below the pickup coil/antenna 1 and extends beyond the pickup coil's outside perimeter. The pickup coil/antenna is glued to the ferrite plate to insure a consistent position.

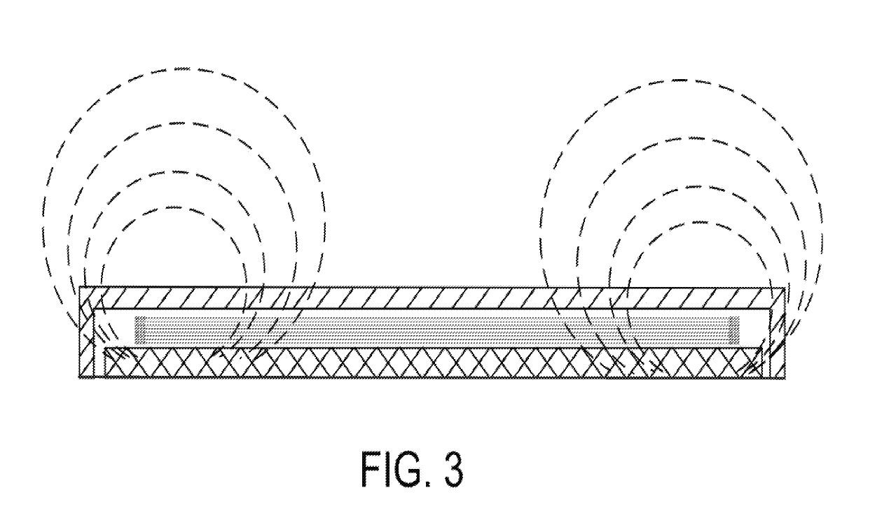

FIG. 3 illustrates how the magnetic field around the front of the antenna is unimpeded while the ferrite material constrains the field in the rear. This effect essentially creates a directional antenna. In viewing the figure the circular dash lines represent the magnetic field. Herein it is able to extend in an upward direction away from the invention itself. This is in contrast to the bottom portion of the device wherein the field is unable to extend. This not only directs the filed but also serves to strengthen its performance.

A complete ultra thin proximity card reader further comprises electronics (not observed in the figures) which include a reader board and wire leads which connect to coil 1. The pickup coil/antenna 1, ferrite plate 3, and wire leads 4 are enclosed inside a non metallic housing 2. The housing shape 2 is square in the figure but may change for aesthetics.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. An improved antenna for making a ultra thin proximity reader whose read range is not affected by a metallic surface where the proximity reader is mounted, the improved antenna comprising:
at least one pickup coil for transmitting signals; and
at least one piece of ferrite material located below the pickup coil and extending beyond the pickup coil's outside perimeter;
wherein the ferrite component is used to prevent signals being absorbed by the metallic surface.

2. The improved antenna of claim 1, wherein the pickup coil may vary from one or two coils to more than 75 coils.

3. The improved antenna of claim 1, wherein the coil can also be made as traces on a small printed circuit board.

4. The improved antenna of claim 1, wherein the ferrite material is available as hard sintered plates and shapes or flexible rubberize versions.

5. The improved antenna of claim 1, wherein the ferrite material may be a solid plate or several small plates.

6. The improved antenna of claim 1 can work with most off-the-shelf reader boards to make an ultra thin proximity reader.

7. The improved antenna of claim 1, wherein the pickup coil antenna transmits a short range radio frequency field at 125 KHz or 13.56 MHz.

8. An ultra thin proximity reader whose read range is not affected by a metallic surface where the proximity reader is mounted, the ultra thin proximity reader comprising:
at least one pickup coil; and
at least one piece of ferrite material located below the pickup coil and extending beyond the pickup coil's outside perimeter;
at least one reader board;
wire leads connected between the coil and the board; and
a non-metallic housing to encompass the coils, ferrite material, and wire leads.

9. The ultra thin proximity reader of claim 8, wherein the pickup coil may vary from one or two coils to more than 75 coils.

10. The ultra thin proximity reader of claim 8, wherein the coil can also be made as traces on a small printed circuit board.

11. The ultra thin proximity reader of claim 8, wherein the ferrite material is available as hard sintered plates and shapes or flexible rubberize versions.

12. The ultra thin proximity reader of claim 8, wherein the ferrite material is a solid plate or several small plates.

13. A method of reducing the thickness of a proximity reader, increasing its read range for detecting fobs and cards and allowing it to be mounted directly on a metallic surface without reducing its performance, the method comprising:
putting at least one pickup coil onto a ferrite plate and attaching the pickup coil to the ferrite plate by gluing or other means; and placing the ferrite plate in conjunction of the pickup coil antenna into an appropriate housing; wherein the ferrite material shields magnetic energy from being absorbed by the metal surface and strengthens and redirects magnetic energy of the proximity card reader forward in one direction.

14. The method of claim 13, the method further comprising placing reader boards, wire leads and other necessary electronics into the appropriate housing; and properly tuning and matching the antenna to a specified load impedance required by the reader board's circuitry.

15. The method of claim 14, wherein the pickup coil may vary from one or two coils to more than 75 coils.

16. The method of claim 14, wherein the ferrite material may be a solid plate or several small plates.
